(19) United States
(12) Patent Application Publication
(10) Pub. No.: US 2024/0149655 A1
(43) Pub. Date: May 9, 2024

(54) STRUCTURAL ASSEMBLY FOR BATTERY STRUCTURE OF ELECTRIC VEHICLE

(71) Applicant: Ford Global Technologies, LLC, Dearborn, MI (US)

(72) Inventors: Scott M. Rollins, Highland, MI (US); Dominic Mario Bertolini, Royal Oak, MI (US); David Doman, Canton, MI (US); Francisco Fernandez-Galindo, Canton, MI (US); John Hammack McCormick, Clawson, MI (US); Jason Luke Sielaff, Brighton, MI (US); Liam E. West, Ferndale, MI (US)

(73) Assignee: Ford Global Technologies, LLC, Dearborn, MI (US)

(21) Appl. No.: 17/980,207

(22) Filed: Nov. 3, 2022

(51) Int. Cl. B60K 1/04; B60L 50/64; H01M 50/209; H01M 50/249

(52) U.S. Cl. CPC B60K 1/04; B60L 50/64; H01M 50/209; H01M 50/249; H01M 2220/20

(57) ABSTRACT

A structural assembly for a battery structure includes a lower wall and a pair of cross members. The lower wall is configured to support a cell stack. The cross members are spaced apart from each other in a longitudinal direction of a vehicle. Each cross member supports a respective side of the cell stack and is configured to extend substantially an entire width of the battery structure. Each cross member includes an outer wall, an inner wall, and connecting members that connect the outer wall to the inner wall. The outer wall, the inner wall, and the connecting members cooperate to define an internal cavity. The inner walls of the cross members are secured to the lower wall to form a unitized structure that houses the cell stack.

### FIELD

The present disclosure relates to a structural assembly for a battery structure of an electric vehicle.

### BACKGROUND

The statements in this section merely provide background information related to the present disclosure and may not constitute prior art.

Electric vehicles differ from conventional motor vehicles because they are driven by one or more rechargeable battery packs having lithium-ion batteries, for example, or any other suitable electrical power storage units. The battery pack typically powers one or more motors to drive a set of wheels using battery arrays. In some electric vehicles, the battery arrays include a structural assembly that surrounds and cools cell stack, especially for vehicles capable of traveling long distances (e.g., electric vehicles capable of traveling more than 500 miles). As some types of batteries age (e.g., pouch and prismatic battery cells), gas can be generated within the cells. This gas generation causes increasing internal stress. Additionally, battery packs can be subject to various vehicle and impact loads.

The present disclosure addresses these and other issues related to battery arrays in electric vehicles.

### SUMMARY

This section provides a general summary of the disclosure and is not a comprehensive disclosure of its full scope or all of its features.

A structural assembly for a battery structure includes a first lower wall and a pair of first cross members. The first lower wall is configured to support a first cell stack. The pair of first cross members are spaced apart from each other in a longitudinal direction of the electric vehicle. Each cross member of the pair of first cross members support a respective side of the first cell stack and is configured to extend substantially an entire width of the battery structure. Each cross member of the pair of first cross members includes an outer wall, an inner wall spaced apart from the outer wall, and connecting members that connect the outer wall to the inner wall. The outer wall, the inner wall, and connecting members cooperate with each other to define an internal cavity. The inner walls of the pair of first cross members are secured to the first lower wall to form a unitized structure that houses the first cell stack.

In variations of the structural assembly of the above paragraph, which can be implemented individually or an any combination: the inner wall of one cross member of the pair of first cross members is secured to the first lower wall by one or more first mechanical fasteners and the inner wall of the other cross member of the pair of first cross members is secured to the first lower wall by one or more second mechanical fasteners; a pair of intermediate walls, one intermediate wall of the pair of intermediate walls is disposed between the one cross member and the first cell stack and secured to the one cross member by the one or more first mechanical fasteners, the other intermediate wall of the pair of intermediate walls is disposed between the other cross member and the first cell stack and secured to the other cross member by the one or more second mechanical fasteners; the pair of intermediate walls have a thickness that is less than a thickness of the pair of first cross members; a lid is secured to the pair of first cross members by mechanical fasteners and covering the first cell stack; a cold plate is housed within the unitized structure and disposed between the first cell stack and the lower wall, the cold plate is in a heat transfer relationship with the first cell stack; the first lower wall is in a heat transfer relationship with the first cell stack; the pair of first cross members extend downwardly past the first lower wall; a first electrical pad is partially disposed within and supported by one cross member of the pair of first cross members and a second electrical pad partially disposed within and supported by the other cross member of the pair of first cross members; a second lower wall is configured to support a second cell stack and is in a heat transfer relationship with the second cell stack, a pair of second cross members are spaced apart from each other in a longitudinal direction of the electric vehicle and secured to ends of the second lower wall, each cross member of the pair of second cross members supporting a respective side of the second cell stack and configured to extend substantially an entire width of the battery structure, one cross member of the pair of second cross members is fluidly connected to one cross member of the pair of first cross members.

In another form, a battery structure for an electric vehicle includes a battery housing and a plurality of modular array structural assemblies. The plurality of modular array structural assemblies are disposed within and secured to the battery housing. Each array structural assembly is configured to house a cell stack. Each array structural assembly includes a lower wall and a pair of cross members. The lower wall is configured to support the cell stack and is in a heat transfer relationship with the cell stack. The pair of cross members are spaced apart from each other in a longitudinal direction of the electric vehicle and extends in a transverse direction relative to the longitudinal direction of the electric vehicle. Each cross member of the pair of cross members supports a respective side of the cell stack and is secured to the lower wall to form a unitized structure. One cross member of the pair of cross members of one array structural assembly is adjacent to another cross member of the pair of cross members of another array structural assembly.

In variations of the structural assembly of the above paragraph, which can be implemented individually or an any combination: a fluid conduit connects the one cross member and the another cross member to each other; a first conductive pad is partially disposed within and supported by one cross member and a second conductive pad is partially disposed within and supported by another cross member; a separate conductive tab has a first portion secured to the first conductive pad and a second portion secured to the second conductive pad; the conductive tab is secured to the first and second conductive pads by one or more mechanical fasteners; a conductive tab is integral with the first conductive pad and secured to the second conductive tab; and the conductive tab is partially disposed within another cross member.

In yet another form, a battery structure for an electric vehicle includes a battery housing and a plurality of array structural assemblies. The plurality of array structural assemblies are disposed within and secured to the battery housing. Each array structural assembly is configured to house a cell stack. Each array structural assembly includes a lower wall, a pair of cross members, and first and second conductive pads. The lower wall is configured to support a cell stack and is in a heat transfer relationship with the cell stack. The pair of cross members are spaced apart from each other in a longitudinal direction of the electric vehicle and extends in a transverse direction relative to the longitudinal direction of the electrical vehicle. Each cross member of the pair of cross members supports a respective side of the cell stack and includes an outer wall, an inner wall, and connecting members that connect the outer wall to the inner wall. The first conductive pad is partially disposed within and supported by the one cross member of the pair of cross members. The second electrical pad is partially disposed within and supported by the other cross member of the pair of cross members. One cross member of the pair of cross members of one array assembly is adjacent to another cross member of the pair of cross members of another array assembly.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery housing assembly according to the principles of the present disclosure;

FIG. 2 is a schematic perspective view of the battery housing assembly of FIG. 1;

FIG. 3 is another perspective view of the battery housing assembly of FIG. 1 with a lid of the battery housing assembly removed for clarity;

FIG. 4 is a cross-sectional view of a battery array of the battery housing assembly of FIG. 1;

FIG. 5 is a cross-sectional view of a plurality of battery arrays of the battery housing assembly of FIG. 1;

FIG. 6 is a cross-sectional view of another battery array that can be incorporated into the battery housing assembly of FIG. 1 according to the principles of the present disclosure;

FIG. 7 is a cross-sectional view of yet another battery array that can be incorporated into the battery housing assembly of FIG. 1 according to the principles of the present disclosure;

FIG. 8 is a cross-sectional view of yet another battery array that can be incorporated into the battery housing assembly of FIG. 1 according to the principles of the present disclosure;

FIG. 9 is a cross-sectional view of a plurality of battery arrays fluidly connected to each other that can be incorporated into the battery housing assembly of FIG. 1 according to the principles of the present disclosure;

FIG. 10 is a cross-sectional view of yet another battery array that can be incorporated into the battery housing assembly of FIG. 1 according to the principles of the present disclosure;

FIG. 11 is a cross-sectional view of a plurality of battery arrays of FIG. 10 electrically connected to each other according to the principles of the present disclosure;

FIG. 12 is a cross-sectional view of yet another battery array that can be incorporated into the battery housing assembly of FIG. 1 according to the principles of the present disclosure;

FIG. 13 is a cross-sectional view of a plurality of battery arrays of FIG. 12 electrically connected to each other according to the principles of the present disclosure; and

FIG. 14 is a cross-sectional view of a plurality of alternate battery arrays electrically connected to each other according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

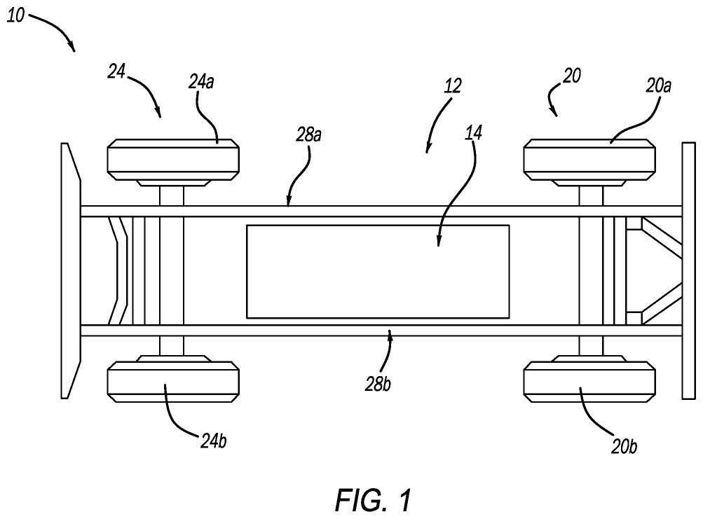

With reference to FIG. 1, a vehicle 10 such as an electric vehicle is shown. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a vehicle frame 12 and a battery structure or battery housing assembly 14. The vehicle frame 12 is the main supporting structure of the vehicle 10, to which various components are attached either directly or indirectly. The vehicle frame 12 includes opposed longitudinal rails 28a, 28b. The rails 28a, 28b are spaced apart from each other and may establish a length of the vehicle frame 12. In the example illustrated, the vehicle 10 is a body on frame vehicle architecture, though other configurations can be used, such as a unibody architecture, for example.

The battery housing assembly 14 powers a rear motor (not shown) to drive rear wheels 20a, 20b of a set of rear wheels 20 via a rear axle and/or powers a front motor (not shown) to drive front wheels 24a, 24b of a set of front wheels 24 via a front axle.

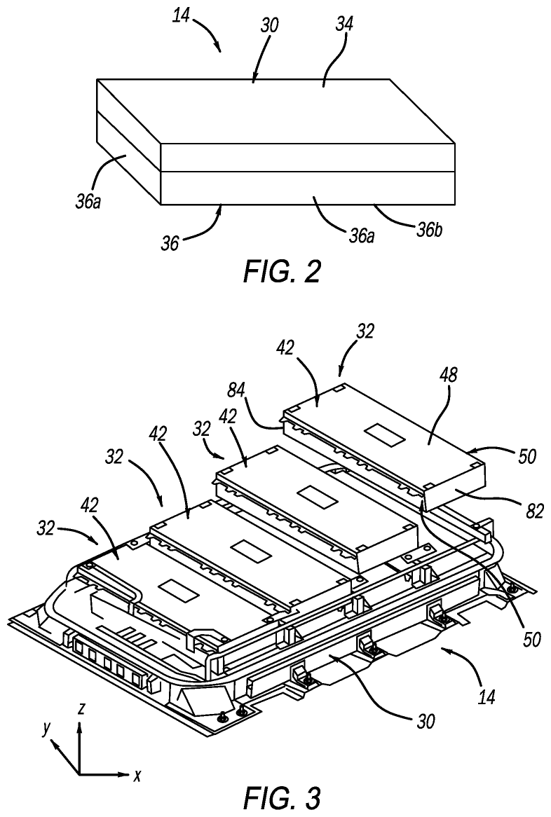

With reference to FIGS. 2 and 3, the battery housing assembly 14 includes a battery tray or housing 30 and one or more battery arrays 32 (FIG. 3). The battery housing 30 is an enclosure which provides a structural surrounding and sealed compartment for the battery arrays 32 and other battery components such as cooling lines, support brackets, and wiring disposed therein or extending therethrough. The battery housing 30 may disposed at various locations of the vehicle 10 and is mounted to the vehicle frame 12. In this way, the battery housing 30 is supported by the vehicle frame 12 and is remote from a passenger cabin (not shown) and cargo compartments (not shown) of the vehicle 10, therefore, not occupying space that would otherwise be available for passengers or cargo. The battery housing 30 includes a cover or lid 34, a body 36, and a seal (not shown). The lid 34 may optionally be removably coupled to the body 36 via mechanical fasteners such as bolts or screws (not shown), for example. In this way, the lid 34 may be removed to service the battery arrays 32 disposed within the battery housing 30.

The body 36 includes a plurality of side walls or panels 36a and a bottom wall or panel 36b. The side walls 36a may be manufactured via stamping, for example, and extend in a vertical direction Z. The side walls 36a define an outer boundary of the battery housing 30 and are secured to each other via welding or an adhesive, for example. The bottom wall 36b supports the battery arrays 32 disposed within the battery housing 30 and is secured to lower portions of the side walls 36a. The seal is disposed around a periphery of the body 36 and is engaged with the body 36 and the lid 34. In this way, fluids, debris and other materials are inhibited from entering into the battery housing 30.

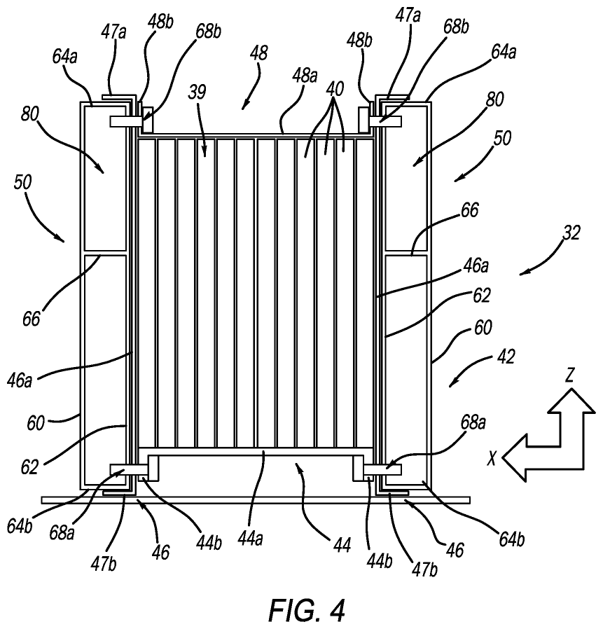

With additional reference to FIG. 4, each battery array 32 may be rechargeable and may include one or more cell stack 39 formed by battery cells 40 (e.g., lithium-ion batteries such as those in which the cell components are enclosed in an aluminum-coated plastic film, or any other suitable electrical power storage units). In the example illustrated, the cell stack 39 are formed by battery cells 40 arranged in a side-by-side configuration. In some forms, the cell stack may be formed by battery cells stacked on each other in a vertical arrangement. Each battery array 32 includes a structural assembly 42 surrounding and supporting the cell stack 39. In some forms, the battery arrays 32 are in fluid communication with each other via connecting lines (not shown). In this way, fluid such as glycol, for example, is allowed to flow through the structural assembly 42 of each battery array 32, thereby cooling the battery cells 40.

Each structural assembly 42 is in the form of a modular structure that can be installed within and removed from the battery housing 30. Each structural assembly 42 also spans substantially an entire width of the battery housing 30 and is configured to transfer loads from one side of the battery housing 30 to an opposite side of the battery housing 30, for example, during certain side impacts. Stated differently, each modular structural assembly 42 is configured to house the battery cells 40 and transfer loads away from the battery cells 40 during certain side impacts. In this way, cross braces in conventional battery housings that act as partitions between battery arrays (i.e., are separate structures from the battery arrays) and that span the width of the battery housing such that the cross braces transfer loads across the battery housing can be eliminated from the battery housing.

Each structural assembly 42 may be removably coupled to the battery housing 30 and includes a cold plate 44, a lid 48 and a pair of cross members 50. In the example illustrated, the cold plate 44 may be manufactured via a stamping process, for example, and is made of a metal material. In some forms, the cold plate 44 may be manufactured via other manufacturing processes such as an extrusion process, for example. In the example illustrated, the cold plate 44 is a lower wall configured to support a cell stack 39 and is in a heat transfer relationship with the cell stack 39. In some forms, the cold plate 44 may be a wall laterally supporting a respective side of the cell stack 39 or a wall covering a top of the cell stack 39. In one example, an upper surface of the cold plate 44 contacts a lower end of the cell stack 39 such that heat generated by the cell stack 39 is transferred to the cold plate 44. As used herein, the term “heat transfer relationship” should be construed to mean an arrangement in which heat from the cell stack 39 is directly or indirectly transferred to one or more cold plates of the structural assembly 42 via thermal conduction. In the example illustrated, the cold plate 44 is also secured to the pair of cross members 50. The cold plate 44 has a uniform thickness and includes a support portion 44a and a pair of flanges 44b. The support portion 44a extends in a horizontal direction and supports the cell stack 39. Each flange 44b extends downward in a vertical direction from a respective end of the support portion 44a and is secured to the pair of cross members 50 (i.e., each flange 44b extends perpendicular from the support portion 44a).

As shown in FIG. 4, each structural assembly 42 may include a pair of optional intermediate walls 46. Each intermediate wall 46 is made of plastic material or a metal material and is disposed between a respective cross member 50 of the pair of cross members 50 and a respective side of the cell stack 39. Each intermediate wall 46 has a solid structure and includes a thickness that is less than a thickness of the cross members 50. In the example illustrated, each intermediate wall 46 is secured to a respective cross member 50 and the cold plate 44, and includes a body portion 46a and a pair of flange portions 47a, 47b. The body portion 46a extends in a vertical direction and is located between the respective cross member 50 and the respective side of the cell stack 39. In the example illustrated, the body portion 46a extends vertically upward a further distance than the respective cross member 50 and extends vertically downward a further distance than the respective cross member 50.

In some forms, the respective cross member 50 extends upward a further distance than the intermediate wall 46 and extends downward a further distance than the intermediate wall 46. The flange portion 47a extends away from the cell stack 39 in a direction perpendicular from an upper end of the body portion 46a and at least partially covers and wraps around an inner portion of a respective cross member 50. Similarly, the flange portion 47b extends away from the cell stack 39 in a direction perpendicular from a lower end of the body portion 46a and at least partially covers and wraps around the inner portion of a respective cross member 50.

The lid 48 is made of a metal material and covers the cell stack 39. The lid 48 has a solid structure and includes a uniform thickness that is less than a thickness of the cross members 50. The lid 48 is secured to the pair of cross members 50 and the intermediate walls 46 and is disposed between the pair cross members 50 and between the intermediate walls 46. The lid 48 includes a body portion 48a and a pair of flange portions 48b. The body portion 48a extends in a horizontal direction and covers a top of the cell stack 39. Each flange portion 48b extends upward in a vertical direction from a respective end of the body portion 48a and is secured to the pair of cross members 50 and the intermediate walls 46. In the example illustrated, the flange portions 48b are substantially flush with upper ends of the pair of cross members 50 and are positioned below the pair of intermediate walls 46. It should be understood that the lid 48 may be secured directly to the pair of cross members 50 in configurations where the structural assembly 42 does not include the intermediate walls 46.

The pair of cross members 50 are spaced apart from each other in the longitudinal direction of the vehicle 10 and extends in a transverse direction relative to the longitudinal direction of the vehicle 10. Each cross member 50 laterally supports a respective side of the cell stack 39 and is made of a metal material such as aluminum, for example. In the example illustrated, each cross member 50 extends downward past the cold plate 44 and extends upward past the lid 48. In the example illustrated, each cross member 50 of the pair of cross members 50 is a single component that extends substantially an entire width of the battery structure 14. In some configurations, each cross member 50 of the pair of cross members 50 is made of two or more adjacent components that together extend substantially an entire width of the battery structure 14 and that are each secured to the bottom wall 36b of the body 36. In some forms of the above configuration, the two or more adjacent components of each cross member 50 may be separate (distinct) from each other. In other forms of the above configuration, the two or more adjacent components of each cross member 50 may be joined to each other by welding, adhesives, fasteners, or any other suitable attachment means.

Each cross member 50 includes an outer wall 60, an inner wall 62, connecting members 64a, 64b and one or more internal stiffening members 66. The outer wall 60 extends in a vertical direction and defines an outer boundary of the battery array 32. The inner wall 62 is spaced apart from the outer wall 60 and extends in a vertical direction. In the example illustrated, the inner walls 62 of the pair of cross members 50 are secured to the cold plate 44 to define a container that the cell stack 39 is disposed in.

In the example illustrated, one or more fasteners 68a extend through a respective flange 44b of the cold plate 44, a lower section of the body portion 46a of a respective intermediate wall 46 and a lower section of the inner wall 62 of a respective cross member 50, thereby securing the cold plate 44, the respective intermediate wall 46 and the respective cross member 50 to each other. Similarly, one or more fasteners 68b extend through a respective flange portion 48b of the lid 48, an upper section of the body portion 46a of a respective intermediate wall 46 and an upper section of the inner wall 62 of a respective cross member 50, thereby securing the lid 48, the respective intermediate wall 46 and the respective cross member 50 to each other. In some forms, the cold plate 44, the respective intermediate wall 46 and the respective cross member 50 may be secured to each other by welding, and the lid 48, the respective intermediate wall 46 and the respective cross member 50 may be secured to each other by welding.

The connecting member 64a extends in a horizontal direction and connects the upper section of the inner wall 62 with an upper section of the outer wall 60. Similarly, the connecting member 64b extends in a horizontal direction and connects the lower section of the inner wall 62 with a lower section of the outer wall 60. The outer wall 60, the inner wall 62 and the connecting members 64a, 64b cooperate to define an internal cavity 80. Each internal stiffening member 66 is disposed within the internal cavity 80 and extends in a horizontal direction from the outer wall 60 to the inner wall 62. In some forms, one or more internal stiffening members 66 may extend in an oblique direction from the outer wall 60 to the inner wall 62, in addition to, or instead of, extending in the horizontal direction from the outer wall 60 to the inner wall 62.

As shown in FIG. 3, a first end wall 82 is oriented vertically and is secured to the structural assembly 42. In one example, the first end wall 82 is secured to one or both of the pair of cross members 50, the lid 48 and/or the cold plate 44. The first end wall 82 covers and supports a first end of the cell stack 39 (FIG. 4). Similarly, a second end wall 84 that is opposite the first end wall 82 is oriented vertically and is secured to the structural assembly 42. In one example, the second end wall 84 is secured to one or both of the pair of cross members 50, the lid 48 and/or the cold plate 44 (FIG. 4). The second end wall 84 covers and supports a second end of the cell stack 39 (FIG. 4) that is opposite the first end of the cell stack 39. The end walls 82, 84 are secured to the structural assembly 42 such that the end walls 82, 84 and the structural assembly 42 cooperate to form the battery array 32, which provides a structural surrounding and sealed compartment for the cell stack 39 (FIG. 4). In one example, the first and second end walls 82, 84 are secured to gussets (not shown), which are, in turn, secured to the battery housing 30.

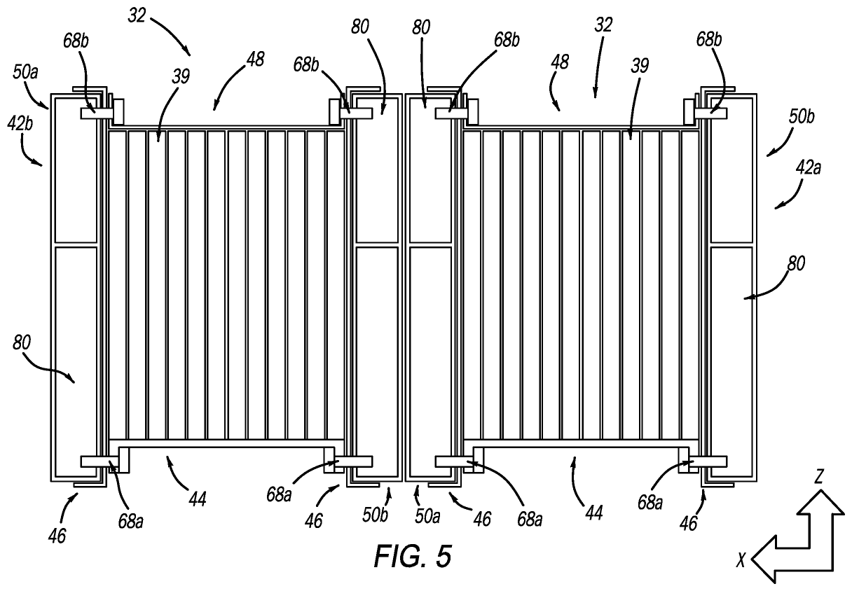

As shown in FIG. 5, the battery arrays 32 are disposed within the battery housing 30 such that one cross member 50a of one array structural assembly 42a is adjacent to another cross member 50b of another adjacent array structural assembly 42b. In this way, the adjacent cross members 50a, 50b allow the transfer of increased impact loads across the width of the battery housing 30 during certain side impacts compared to a configuration in which there is only one cross member. As used herein, adjacent cross members should be construed to mean cross members from two different structural assemblies that are not separated by a battery array or one or more components of a battery array (i.e., cross members from two different structural assemblies that do not include a battery array or one or more components of a battery array disposed between). In the example illustrated, the cross members 50a, 50b of the adjacent structural assemblies 42a, 42b are spaced apart from each other. In some configurations, the cross members 50a, 50b of the adjacent structural assemblies 42a, 42b engage or contact each other, such as being removably coupled together, for example.

The structural assembly 42 of the present disclosure provides multiple functions such as load paths, heat transfer, and fluid flow paths. In one example, the cross members 50 of each structural assembly 42 is configured to house the battery cells 40 and transfer loads across the battery housing 30 away from the battery cells 40 during certain side impacts. In some forms, the structural assembly 42 may be additively manufactured as a monolithic structure in which one or more walls include an internal lattice structure to provide fluid flow paths for cooling fluid flowing through the structural assembly 42.

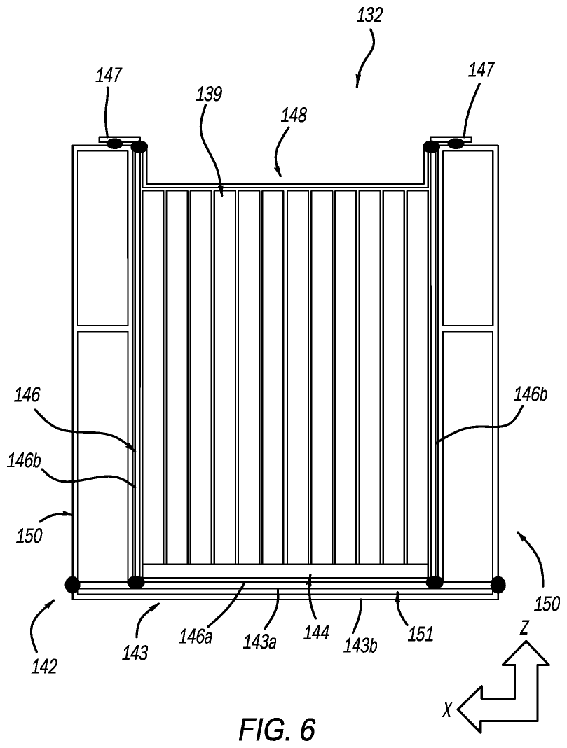

With reference to FIG. 6, another battery array 132 is illustrated. The battery array 132 may be incorporated into the battery housing assembly 14 described above instead of, or in addition to, the battery array 32 described above. The structure and function of the battery array 132 may be similar or identical to the battery array 32 described above, apart for any differences noted below.

The battery array 132 includes a structural assembly 142 surrounding and supporting one or more cell stacks 139. The structural assembly 142 may be removably coupled to the battery housing 30 described above and includes a bottom beam 143, a cold plate 144, a lid 148, and a pair of cross members 150.

The bottom beam 143 may be manufactured using an extrusion process, for example, and supports the cold plate 144 and the cell stack 139. The bottom beam 143 is fixed to (i.e., welded to) the pair of cross members 150 to form a U-shaped unitized structure that houses the cold plate 144 and the cell stack 139. The bottom beam 143 includes an upper wall 143a and a lower wall 143b that are spaced apart from one another such that they cooperate with each other to define an internal cavity 151 therebetween. The bottom beam 143 includes a thickness that is less than a thickness of each cross member 150 of the pair of cross members 150. In some forms, the bottom beam 143 includes a thickness that is equal to a thickness of each cross member 150.

The structure and function of the cold plate 144 and the lid 148 may be similar or identical to that of the cold plate 44 and the lid 48, respectively, described above, and therefore, will not be described again in detail.

An optional intermediate 146 wall may be disposed within the unitized structure formed by the bottom beam 143 and the pair of cross members 150. In the example illustrated, the intermediate wall 146 is welded to the bottom beam 143 and the pair of cross members 150, and includes a lower portion 146a, side portions 146b, and a pair of flange portions 147. The lower portion 146a extends in a horizontal direction and is located between the cold plate 144 and the bottom beam 143. The cold plate 144 is also in thermal contact with the lower portion 146a. Each side portion 146b extends in a vertical direction and is located between a respective cross member 150 and a respective side of the cell stack 139. Each flange portion 147 extends away from the cell stack 139 in a direction perpendicular from an upper end of a respective body portion 146b and at least partially covers and wraps around an inner portion of a respective cross member 150.

Each cross member 150 of the pair of cross members 150 sit on a respective end of the bottom beam 143. The structure and function of the pair of cross members 150 may be similar or identical to that of the pair of cross members 50, described above, and therefore, will not be described again in detail.

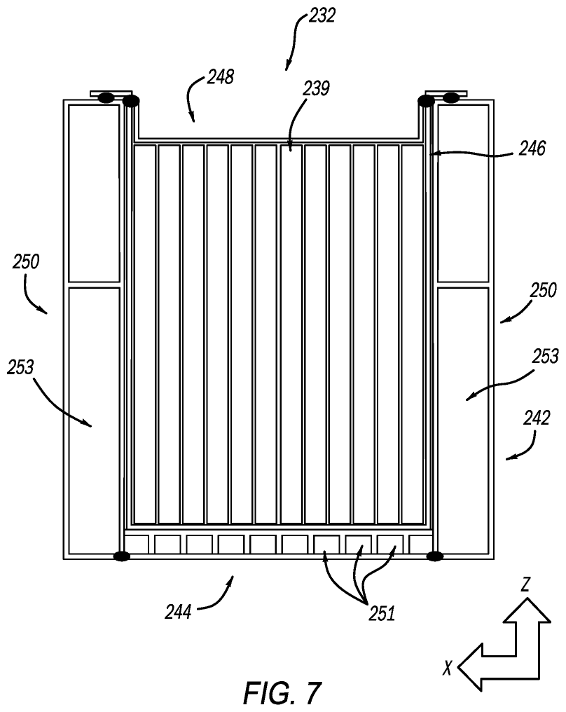

With reference to FIG. 7, another battery array 232 is illustrated. The battery array 232 may be incorporated into the battery housing assembly 14 described above instead of, or in addition to, the battery arrays 32, 132 described above. The structure and function of the battery array 232 may be similar or identical to the battery arrays 32, 132 described above, apart for any differences noted below.

The battery array 232 includes a structural assembly 242 surrounding and supporting the cell stack 239. The structural assembly 242 may be removably coupled to the battery housing 30 described above and includes a cold plate 244, an optional intermediate wall 246, a lid 248, and a pair of cross members 250.

The cold plate 244 may be manufactured using an extrusion process, for example, and supports the cell stack 239. The cold plate 244 is fixed to (i.e., welded to) the pair of cross members 250 to form a U-shaped unitized structure that houses the cell stack 239. The cold plate 244 is in a heat transfer relationship with the cell stack 239 and includes a thickness that is less than a thickness of each cross member 250 of the pair of cross members 250. In some forms, the cold plate 244 includes a thickness that is equal to a thickness of each cross member 250. In the example illustrated, fluid such as glycol, for example, is allowed to flow through channels 251 of the cold plate 244, thereby cooling the cell stack 239. The channels 251 are fluidly isolated from internal cavities 253 of the pair of cross members 250.

The structure and function of the intermediate wall 246, the lid 248, and the pair of cross members 250 may be similar or identical to that of the intermediate walls 146, the lid 48, and the pair of cross members 50, respectively, described above, and therefore, will not be described again in detail.

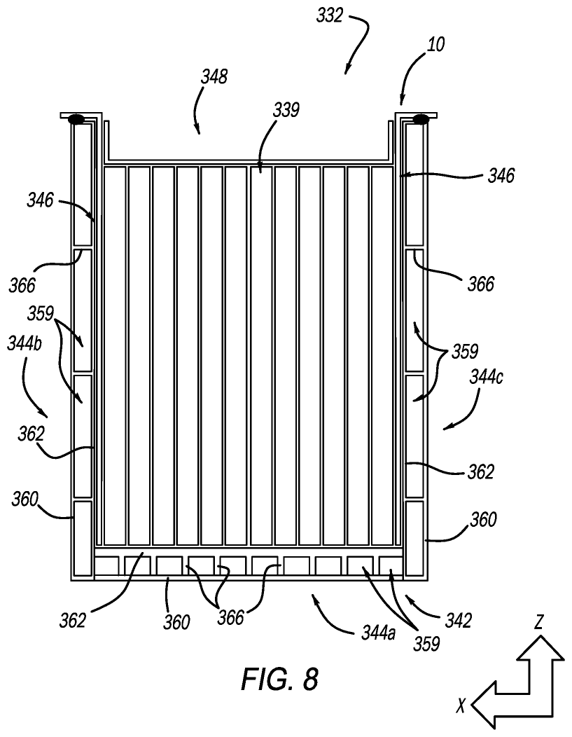

With reference to FIG. 8, another battery array 332 is illustrated. The battery array 332 may be incorporated into the battery housing assembly 14 described above instead of, or in addition to, the battery arrays 32, 132, 232 described above. The structure and function of the battery array 332 may be similar or identical to the battery arrays 32, 132, 232 described above, apart for any differences noted below.

The battery array 332 includes a structural assembly 342 surrounding and supporting the cell stack 339. The structural assembly 342 may be removably coupled to the battery housing 30 described above and includes a plurality of support structures 344a, 344b, 344c, optional intermediate walls 346, and a lid 348.

The support structures 344a, 344b, 344c may be manufactured using an extrusion process, for example, and support a respective side of the cell stack 339. That is, support structure 344a extends in a horizontal direction and supports a bottom of the cell stack 339, support structure 344b extends in a vertical direction and supports a left side of the cell stack 339, and support structure 344c extends in a vertical direction and supports a right side of the cell stack 339. The support structures 344a, 344b, 344c are fixed to each other to form a U-shaped unitized structure that houses the cell stack 339. Each of the support structures 344a, 344b, 344c is in a heat transfer relationship with the cell stack 339 and has a thickness equal to each other.

Each support structure 344a, 344b, 344c includes an outer wall 360, an inner wall 362, and a plurality of internal dividers 366. The outer wall 360 defines an outer boundary of the battery array 332. The inner wall 362 is spaced apart from the outer wall 360 and may contact the cell stack 339. The internal dividers 366 extend perpendicular to the outer and inner walls 360, 362, and connect the outer and inner walls 360, 362 to each other. In the example illustrated, fluid such as glycol, for example, is allowed to flow through channels 359 formed by the internal dividers, thereby cooling the cell stack 339. The channels 359 of the support structures 344a, 344b, 344c may be in fluid communication with each other. That is, fluid may flow sequentially through the support structure 344b, then the support structure 344a, then the support structure 344c and out of the structural assembly 342.

The structure and function of the intermediate walls 346 and the lid 348 may be similar or identical to that of the intermediate walls 46 and the lid 48, respectively, described above, and therefore, will not be described again in detail.

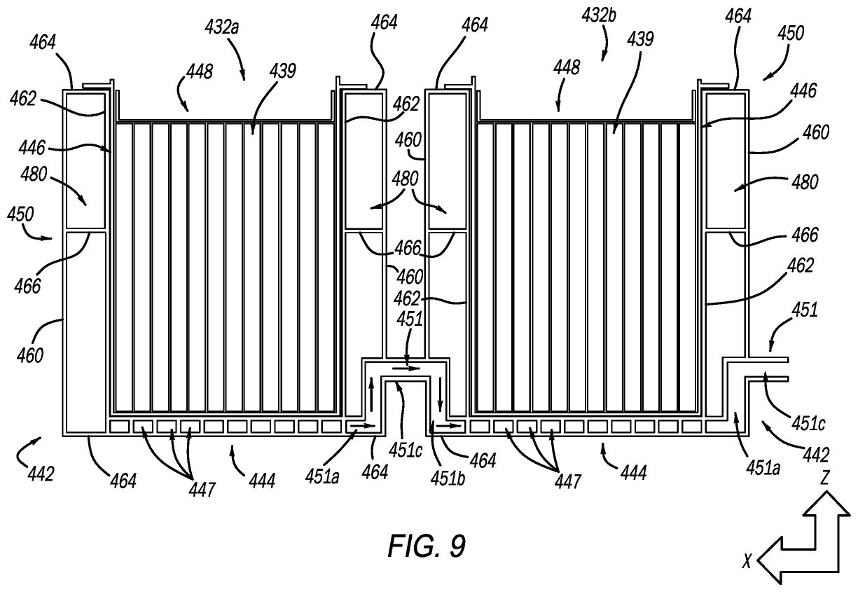

With reference to FIG. 9, battery arrays 432a, 432b are illustrated. The battery array 432a, 432b may be incorporated into the battery housing assembly 14 described above instead of, or in addition to, the battery arrays 32, 132, 232, 332 described above. The structure and function of the battery array 432a, 432b may be similar or identical to the battery arrays 32, 132, 232, 332 described above, apart for any differences noted below.

Each battery array 432a, 432b includes a structural assembly 442 surrounding and supporting the cell stack 439. The structural assembly 442 may be removably coupled to the battery housing 30 described above and includes a cold plate 444, an optional intermediate wall 446, a lid 448, and a pair of cross members 450.

The cold plate 444 may be manufactured using an extrusion process, for example, and supports the cell stack 439. The cold plate 444 is fixed to (i.e., welded to) the pair of cross members 450 to form a U-shaped unitized structure that houses the cell stack 439. The cold plate 444 is in a heat transfer relationship with the cell stack 239 and allows fluid such as glycol, for example, to flow through channels 447 formed in the cold plate 444, thereby cooling the cell stack 439.

The structure and function of the intermediate walls 246 and the lid 248 may be similar or identical to that of the intermediate wall 146 and the lid 48, respectively, described above, and therefore, will not be described again in detail.

Each cross member 450 includes an outer wall 460, an inner wall 462, connecting members 464 and one or more internal stiffening members 466. The outer wall 460 extends in a vertical direction and defines an outer boundary of the respective battery array 432a, 432b. The inner wall 462 is spaced apart from the outer wall 460 and extends in a vertical direction. The connecting members 464 extend in a horizontal direction and connect the inner wall 462 and the outer wall 460 to each other. The outer wall 460, the inner wall 462 and the connecting members 464 cooperate to define an internal cavity 480. Each internal stiffening member 466 is disposed within the internal cavity 480 and extends in a horizontal direction from the outer wall 460 to the inner wall 462.

A fluid port 451 is in fluid communication with adjacent battery arrays 432a, 432b and may allow fluid such as glycol, for example, to flow between the battery arrays 432a, 432b, thereby cooling the cell stack 439 of the battery arrays 432a, 432b. Fluid flowing through the fluid port 451 is fluidly isolated from the internal cavities 480 of the battery arrays 432a, 432b. In the example illustrated, the fluid port 451 includes a first internal portion 451a, a second internal portion 451b and an external portion 451c. The first internal portion 451a is at least partially disposed within the internal cavity 480 of the cross member 450 of battery array 432a and is in fluid communication with the channels 447 of the cold plate 444 of the battery array 432a. Similarly, the second internal portion 451b is at least partially disposed within the internal cavity 480 of the cross member 450 of the battery array 432b and is in fluid communication with the channels 447 of the cold plate 444 of the battery array 432b.

In the example illustrated, the external portion 451c extends in a horizontal direction and is partially located outside of the battery arrays 432a, 432b between the first and second internal portions 451a, 451b. In some forms, the external portion 451c may extend in an oblique direction relative to the first and second internal portions 451a, 451b instead of extending in a perpendicular direction relative to the first and second internal portions 451a, 451b. The external portion 451c is located above the cold plates 444 of the battery arrays 432a, 432b and may extend through the outer walls 460 of adjacent battery arrays 432a, 432b. The external portion 451c is also in fluid communication with the first and second internal portions 451a, 451b. In this way, as shown by arrows in FIG. 9, fluid may flow from the cold plate 444 of the battery array 432a, through the portions 451a, 451b, 451c of the fluid portion 451 and to the cold plate 444 of the battery array 432b, thereby cooling the cell stack 439 of the battery arrays 432a, 432b.

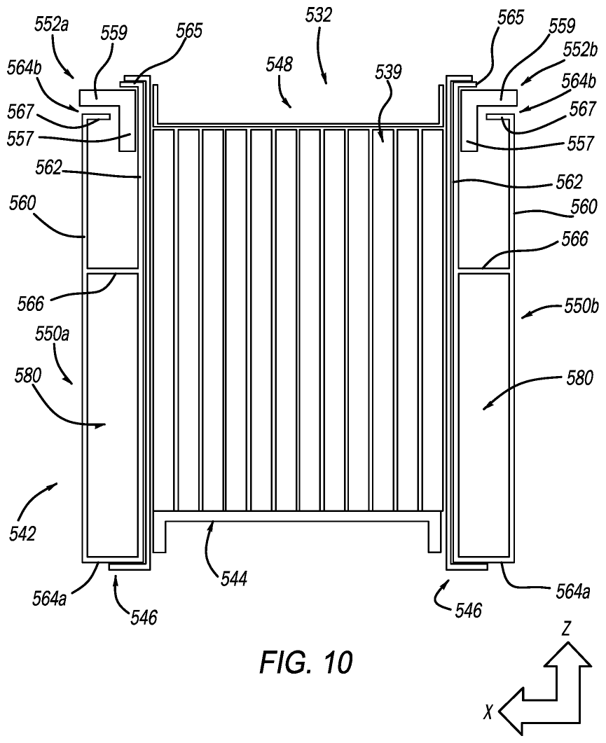

With reference to FIGS. 10-13, another battery array 532 is illustrated. The battery array 532 may be incorporated into the battery housing assembly 14 described above, instead of, or in addition to, the battery arrays 32, 132, 232, 332, 432 described above. The structure and function of the battery array 532 may be similar or identical to the battery arrays 32, 132, 232, 332, 432 described above, apart for any differences noted below.

With reference to FIG. 10, the battery array 532 includes a structural assembly 542 surrounding and supporting the cell stack 539. The structural assembly 542 may be removably coupled to the battery housing 30 described above and includes a bottom a cold plate 544, optional intermediate walls 546, a lid 548, a pair of cross members 550a, 550b, and a pair of conductive pads 552a, 552b.

The structure and function of the cold plate 544, intermediate walls 546, and the lid 548 may be similar or identical to that of the cold plate 44, the intermediate walls 46, and the lid 48, respectively, described above, and therefore, will not be described again in detail.

Each cross member 550a, 550b includes an outer wall 560, an inner wall 562, connecting members 564a, 564b and one or more internal stiffening members 566. The outer wall 560, the inner wall 562 and the connecting members 564a, 564b cooperate to define an internal cavity 580. The outer wall 560 extends in a vertical direction and defines an outer boundary of the battery array 532. The inner wall 562 is spaced apart from the outer wall 560 and extends upwardly in a vertical direction past the outer wall 560.

The connecting members 564a extend in a horizontal direction and connect a lower end of the inner wall 562 and a lower end of the outer wall 560 to each other. Each connecting member 564b is a discontinuous body that includes an upper connecting portion 565 and a lower connecting portion 567 spaced apart from the upper connecting portion 565. In the example illustrated, the upper connecting portion 565 extends in a horizontal direction from an upper end of the inner wall 562 toward the outer wall 560. Stated differently, the upper connecting portion 565 extends perpendicularly from the upper end of the inner wall 562 toward the outer wall 560. In the example illustrated, the lower connecting portion 567 is spaced apart below the upper connecting portion 565 and extends in a horizontal direction from an upper end of the outer wall 560 toward the inner wall 562. Stated differently, the lower connecting portion 567 extends perpendicularly from the upper end of the outer wall 560 toward the inner wall 562. Each internal stiffening member 566 is disposed within the internal cavity 580 and extends in a horizontal direction from the outer wall 560 to the inner wall 562.

The pair of conductive pads 552a, 552b are connected to a power source (not shown) and are at least partially disposed within respective cavities 580 of the cross members 550a, 550b. That is, in the example illustrated, the conductive pad 552a is at least partially disposed within the cavity 580 of the cross member 550a, and the conductive pad 552b is at least partially disposed within the cavity 580 of the cross member 550b. The conductive pad 552a is made of a conductive material that is different than a conductive material of the conductive pad 552b. Each conductive pad 552a, 552b has an L-shape and includes a vertical portion 557 and a horizontal portion 559. The vertical portion 557 is disposed within the cavity 580 of the respective cross member 550a, 550b and is welded to the inner wall 562 of the respective cross member 550a, 550b. In some forms, the vertical portion 557 may be secured to the inner wall 562 of the respective cross member 550a, 550b by mechanical fasteners (not shown). The horizontal portion 559 is positioned below the upper connecting portion 565 and extends outwardly past the outer wall 560 of the respective cross member 550a, 550b. In one form, the horizontal portion 559 is spaced apart from the upper connecting portion 565 and the lower connecting portion 567. In another form, the horizontal portion 559 engages one or both of the upper connecting portion 565 and the lower connecting portion 567.

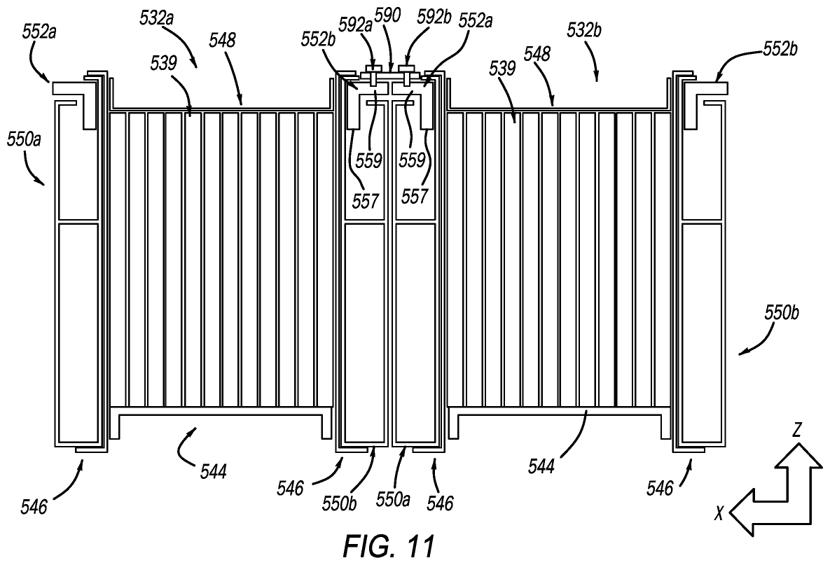

As shown in FIG. 11, the conductive pad 552a from one battery array 532b is electrically connected to the conductive pad 552b from another adjacent battery array 532a by a conductive tab 590. In the example illustrated, the conductive tab 590 is disposed on and overlapping the conductive pads 552a, 552b from the battery arrays 532b, 532a, respectively. One or more fasteners 592a may extend through the conductive tab 590 and at least partially through conductive pad 552b of the battery array 532a to secure the conductive tab 590 to the conductive pad 552b of the battery array 532a. Similarly, one or more fasteners 592b may extend through the conductive tab 590 and at least partially through conductive pad 552a of the battery array 532b to secure the conductive tab 590 to the conductive pad 552a of the battery array 532b. In one form, the conductive tab 590 is made of a conductive material that is the same as the conductive material of the conductive pad 552a. In another form, the conductive tab 590 is made of a conductive material that is the same as the conductive material of the conductive pad 552b.

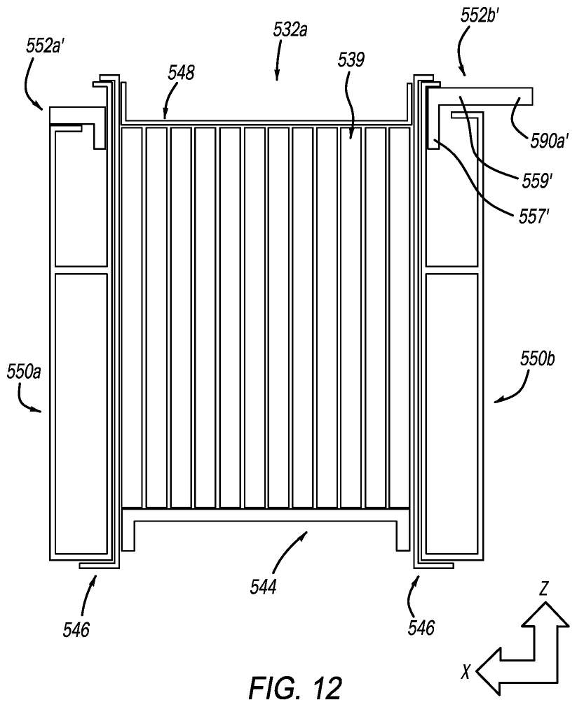

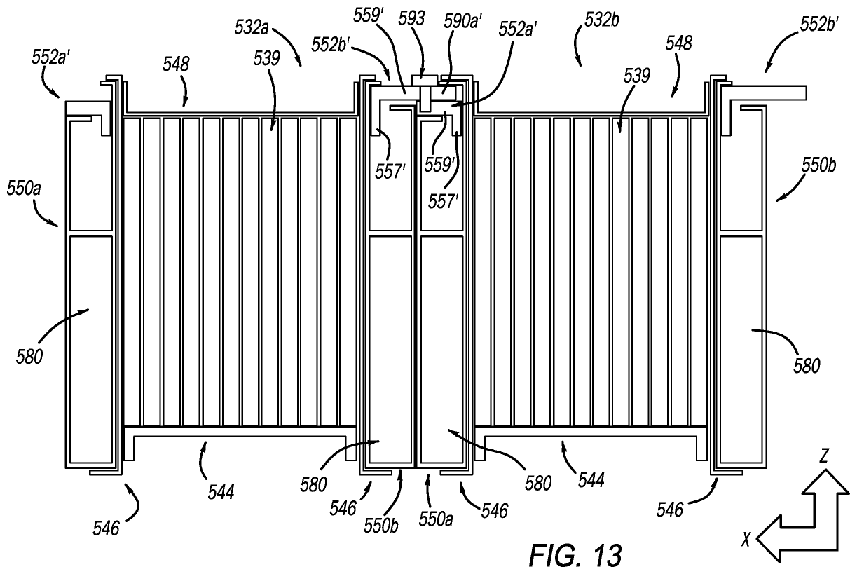

In an alternative form, as shown in FIGS. 12 and 13, the conductive tab 590a′ is integral with the horizontal portion 559′ of the conductive pad 552b′ of battery array 532a and electrically connects that conductive pad 552b′ of the battery array 532a and the conductive pad 552a′ of battery array 532b to each other. Stated differently, the conductive tab 590a′ and the conductive pad 552b′ form a single piece made of the same conductive material. The conductive tab 590a′ overlaps and is located above the conductive pad 552a′ of the battery array 532b. The conductive tab 590a′ also extends partially into the cavity 580 of the cross member 550a of the battery array 532b. One or more fasteners 593 may extend through the conductive tab 590a′ and at least partially through the horizontal portion 559′ of the conductive pad 552a′ of the battery array 532b to secure the conductive tab 590a′ to the conductive pad 552a′ of the battery array 532b.

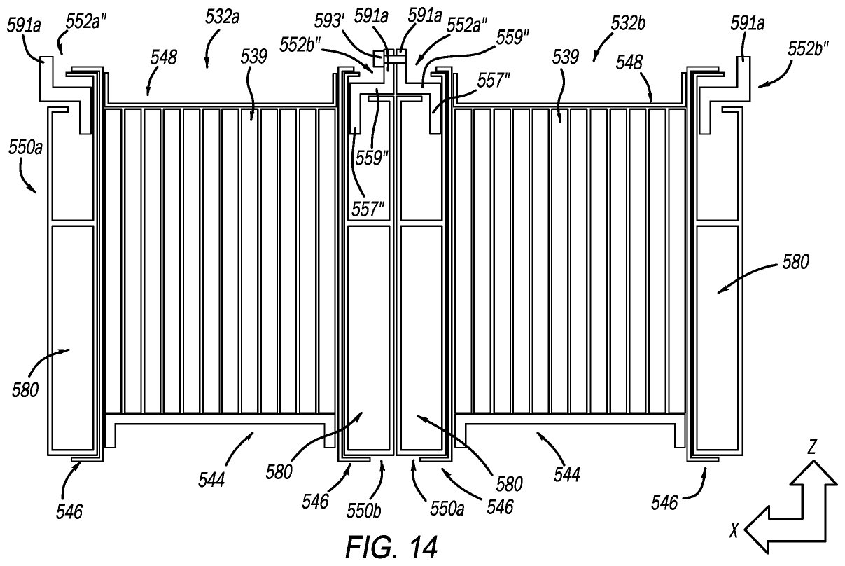

In an alternate form, as shown in FIG. 14, each of the conductive pads 552a″, 552b″ includes an integral conductive tab 591a. That is, the conductive tab 591a extends upward from a first end of the horizontal portion 559″ of the conductive pad 552a″, 552b″ (i.e., the conductive tab 591a extends upward from a first end of the horizontal portion 559″ and the vertical portion 557″ extends downward from a second end of the horizontal portion 559″ that is opposite the first end) and is located partially outside the cavity 580 of the respective cross members 550a, 550b. The conductive tab 591a of the conductive pad 552a″ of battery array 532a is electrically connected to the conductive tab 591a of the conductive pad 552b″ of battery array 532b. That is, one or more fasteners 593′ may extend through the conductive tab 591a of the conductive pad 552a″ of battery array 532a and through conductive tab 591a of the conductive pad 552b″ of battery array 532b to electrically connect the battery arrays 532a, 532b to each other.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A structural assembly for a battery structure of an electric vehicle, the structural assembly comprising:
a first lower wall configured to support a first cell stack; and
a pair of first cross members spaced apart from each other in a longitudinal direction of the electric vehicle, each cross member of the pair of first cross members supporting a respective side of the first cell stack and configured to extend substantially an entire width of the battery structure,
wherein each cross member of the pair of first cross members comprises an outer wall, an inner wall spaced apart from the outer wall, and connecting members that connect the outer wall to the inner wall, the outer wall, the inner wall, and connecting members cooperate with each other to define an internal cavity, and
wherein the inner walls of the pair of first cross members are secured to the first lower wall to form a unitized structure that houses the first cell stack.

2. The structural assembly of claim 1, wherein the inner wall of one cross member of the pair of first cross members is secured to the first lower wall by one or more first mechanical fasteners and the inner wall of the other cross member of the pair of first cross members is secured to the first lower wall by one or more second mechanical fasteners.

3. The structural assembly of claim 2, further comprising a pair of intermediate walls, one intermediate wall of the pair of intermediate walls disposed between the one cross member and the first cell stack and secured to the one cross member by the one or more first mechanical fasteners, the other intermediate wall of the pair of intermediate walls disposed between the other cross member and the first cell stack and secured to the other cross member by the one or more second mechanical fasteners.

4. The structural assembly of claim 3, wherein the pair of intermediate walls have a thickness that is less than a thickness of the pair of first cross members.

5. The structural assembly of claim 1, further comprising a lid secured to the pair of first cross members by mechanical fasteners and covering the first cell stack.

6. The structural assembly of claim 1, further comprising a cold plate housed within the unitized structure and disposed between the first cell stack and the lower wall, the cold plate in a heat transfer relationship with the first cell stack.

7. The structural assembly of claim 1, wherein the first lower wall is in a heat transfer relationship with the first cell stack.

8. The structural assembly of claim 1, wherein the pair of first cross members extend downwardly past the first lower wall.

9. The structural assembly of claim 1, further comprising a first electrical pad partially disposed within and supported by one cross member of the pair of first cross members and a second electrical pad partially disposed within and supported by the other cross member of the pair of first cross members.

10. The structural assembly of claim 1, further comprising:
a second lower wall configured to support a second cell stack and in a heat transfer relationship with the second cell stack; and
a pair of second cross members spaced apart from each other in a longitudinal direction of the electric vehicle and secured to ends of the second lower wall, each cross member of the pair of second cross members supporting a respective side of the second cell stack and configured to extend substantially an entire width of the battery structure,
wherein one cross member of the pair of second cross members is fluidly connected to one cross member of the pair of first cross members.

11. A battery structure for an electric vehicle, the battery structure comprising:
a battery housing; and
a plurality of modular array structural assemblies disposed within and secured to the battery housing, each array structural assembly configured to house a cell stack, each array structural assembly comprising:
a lower wall configured to support the cell stack and in a heat transfer relationship with the cell stack; and
a pair of cross members spaced apart from each other in a longitudinal direction of the electric vehicle and extending in a transverse direction relative to the longitudinal direction of the electric vehicle, each cross member of the pair of cross members supporting a respective side of the cell stack and secured to the lower wall to form a unitized structure,
wherein one cross member of the pair of cross members of one array structural assembly is adjacent to another cross member of the pair of cross members of another array structural assembly.

12. The battery structure of claim 11, wherein each cross member comprises an outer wall, an inner wall spaced apart from the outer wall, and connecting members connecting the outer wall and the inner wall to each other.

13. The battery structure of claim 11, wherein one cross member of the pair of cross members is secured to the lower wall by one or more first mechanical fasteners and the other cross member of the pair of cross members is secured to the lower wall by one or more second mechanical fasteners.

14. The battery structure of claim 11, wherein a fluid conduit connects the one cross member and the another cross member to each other.

15. The battery structure of claim 11, further comprising a first conductive pad partially disposed within and supported by the one cross member and a second conductive pad partially disposed within and supported by the another cross member.

16. The battery structure of claim 15, further comprising a separate conductive tab having a first portion secured to the first conductive pad and a second portion secured to the second conductive pad.

17. The battery structure of claim 16, wherein the conductive tab is secured to the first and second conductive pads by one or more mechanical fasteners.

18. The battery structure of claim 15, further comprising a conductive tab integral with the first conductive pad and secured to the second conductive pad.

19. The battery structure of claim 18, wherein the conductive tab is partially disposed within the another cross member.

20. A battery structure for an electric vehicle, the battery structure comprising:
a battery housing; and
a plurality of array structural assemblies disposed within and secured to the battery housing, each array structural assembly configured to house a cell stack, each array structural assembly comprising:
a lower wall configured to support the cell stack and in a heat transfer relationship with the cell stack;
a pair of cross members spaced apart from each other in a longitudinal direction of the electric vehicle and extending in a transverse direction relative to the longitudinal direction of the electric vehicle, each cross member of the pair of cross members supporting a respective side of the cell stack and comprising an outer wall, an inner wall, and connecting members connecting the outer wall and the inner wall to each other;
a first conductive pad partially disposed within and supported by the one cross member of the pair of cross members; and
a second conductive pad partially disposed within and supported by the other cross member of the pair of cross members,
wherein one cross member of the pair of cross members of one array assembly is adjacent to another cross member of the pair of cross members of another array assembly.
